(19) United States
(12) Patent Application Publication
(10) Pub. No.: US 2014/0188617 A1
(43) Pub. Date: Jul. 3, 2014

(54) METHOD AND SYSTEM FOR PROVIDING DYNAMIC CONSUMER OFFERS

(71) Applicant: Madhusudan RAMAN, Sherborn, MA (US)

(72) Inventor: Madhusudan RAMAN, Sherborn, MA (US)

(73) Assignee: Verizon Patent and Licensing, Inc., Basking Ridge, NJ (US)

(21) Appl. No.: 13/728,594

(22) Filed: Dec. 27, 2012

(51) Int. Cl. G06Q 30/02

(52) U.S. Cl. CPC G06Q 30/0261
USPC 705/14.58

(57) ABSTRACT

An approach for providing consumption behavior modification is described. Location information associated with a mobile device is received as part of a consumption behavior modification service. An applicable behavior modification grid tile is identified based on the location information, wherein the behavior modification grid tile is among a plurality of modification grid tiles mapping to a behavior continuum space. One of a plurality of offers designated for the identified grid is selected. An incentive message specifying a behavior modification inducement incentive is generated for transmission to the mobile device.

### BACKGROUND INFORMATION

The competition for market shares have lead many retailers and service providers to offer greater and greater incentives to encourage current customers to purchase more products or services, as well as to entice new customers to try the product or service in the first instance. One popular approach involves the use of coupons that require the consumer to proactively seek products of interest, e.g., coupons (physical or electronic) disseminated within a newspaper. These coupons are not focused on the habits or preferences of the consumer, but rather strictly rely on the product to “sell” itself along with the potential cost saving. Consequently, coupons can remain unredeemed if the interested consumer does not find them. In recognition of this drawback, retailers have devised more “push”-based rewards programs that actively identify potentially interested consumers by using the consumers' purchase history. This approach, however, fails to capture the sales experience that can augment or enhance the sale, from the perspective of increasing revenue. In other words, if proper incentives were better timed (in terms of presentation to the consumer), the consumer may be motivated to purchase more. Traditional incentive programs generally do not seek to modify the consumer's behavior. Furthermore, if the incentives are not made convenient, consumers are likely to not be incentivized to try a new product or service.

Based on the foregoing, there is a need for a convenient, effective mechanism to modify the consumer's behavior.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system for providing consumption behavior modification, according to one embodiment;

FIG. 2 is a flowchart of process for providing consumption behavior modification, according to one embodiment;

FIG. 3A is a diagram depicting the lifecycle managed service specific components of a behavior modification campaign platform, according to one embodiment;

FIG. 3B is a diagram depicting the components of a behavior modification campaign platform, according to one embodiment;

FIG. 4 is a diagram of an example of a behavior continuum showing a 5×5 behavior propensity matrix, according to one embodiment;

FIGS. 5A and 5B are flowcharts of processes for providing behavior modification campaign services, according to various embodiments;

FIGS. 6 and 7 are diagrams of a mobile device configured to provide a user interface that supports a behavior modification service, according to various embodiments;

FIG. 8 is a diagram of a computer system that can be used to implement various exemplary embodiments; and

FIG. 9 is a diagram of a chip set that can be used to implement an embodiment of the invention.

### DESCRIPTION OF THE PREFERRED EMBODIMENT

An apparatus, method and software for providing dynamic consumer offers are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

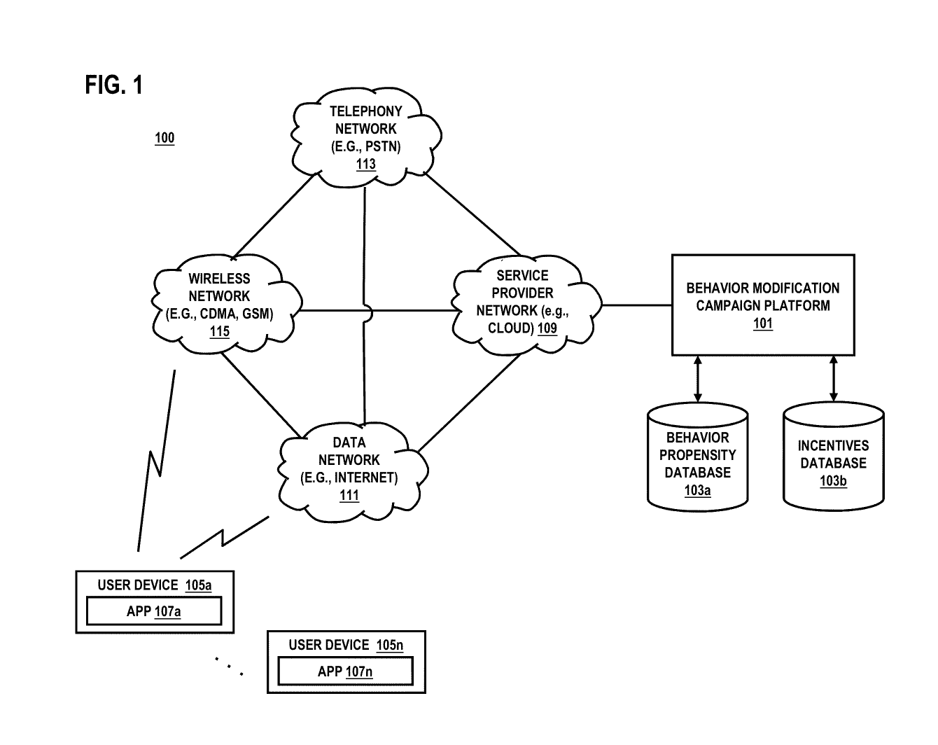

FIG. 1 is a diagram of a system for providing consumption behavior modification, according to one embodiment. For the purposes of illustration, system 100 provides a consumption behavior modification service via a behavior modification campaign platform 101, which dynamically generates consumer offers. In certain embodiments, platform 101 enables a cloud-based targeted behavior modification campaign using quest “gamification” principles. Behavior modification campaign platform 101 automatically tracks and stores statistics for the campaign within one or more databases, e.g., a behavior propensity database 103a. Platform 101 can determine a proper incentive or reward enumerated with an incentives database 103b, which can aggregate various incentives or rewards; it is contemplated that the incentives database 103b can be external to the platform 101 (e.g., maintained by a third party). In some embodiments, the behavior modification campaign platform 101 can activate a predictive model (e.g., predictive model markup language (PMML)) to predict behavior propensity and inducement behavior experimental choices, and determine effectiveness of the predictive model. Additionally, the platform 101 can modify the predictive model according to the determined effectiveness, and deploy situational analytics instance based on the modified predictive model.

In the example of FIG. 1, user devices 105a-105n execute applications 107a-107n, respectively, to interact with behavior modification campaign platform 101 to request incentive based offers. Each of the applications 107a-107n can utilize a graphical user interface (GUI) to facilitate identification of desired behavior goal state. The GUI may also supply feedback information to the platform 101 to modify the behavior pattern for the corresponding user. For example, platform 101 in conjunction with one of the applications 107a-107n provides breakdown of the campaign via dynamic back propagation as a provable statistical experiment. Also, platform 101 can automate association of incentives. Further, as mentioned, behavior modification campaign platform 101, in some embodiments, can incorporate quest and strategy games in which the user is engaged in.

The behavior modification campaign platform 101 may be implemented for execution within a service provider network as a cloud service or a hosted service, for instance. According to certain embodiments, one or more networks, such as data network 111, telephony network 113 and/or wireless network 115, can interact with the service provider network 109. Networks 109-115 may be any suitable wireline and/or wireless network, and be managed by one or more service providers. For example, telephony network 113 may include a circuit-switched network, such as the public switched telephone network (PSTN), an integrated services digital network (ISDN), a private branch exchange (PBX), or other like network. Wireless network 115 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), a heterogeneous network (HetNet) or Regional Area Network (RAN) using multiple types of access nodes in a wireless network including a Wide Area Network utilizing macrocells, picocells and/or femtocells, the Internet, or any other suitable packet-switched network, such as a commercially owned, proprietary packet-switched network, such as a proprietary cable or fiber-optic network.

Although depicted as separate entities, networks 109-115 may be completely or partially contained within one another, or may embody one or more of the aforementioned infrastructures. For instance, service provider network 109 may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of system 100. In this manner, networks 109-115 may embody or include portions of a signaling system 7 (SS7) network, Internet protocol multimedia subsystem (IMS), or other suitable infrastructure to support control and signaling functions. The platform 101 may be further interfaced with external networks, including those of third party content providers (e.g., advertisements), by way of various network interface and sharing arrangements and policies to integrate with one or more merchant services.

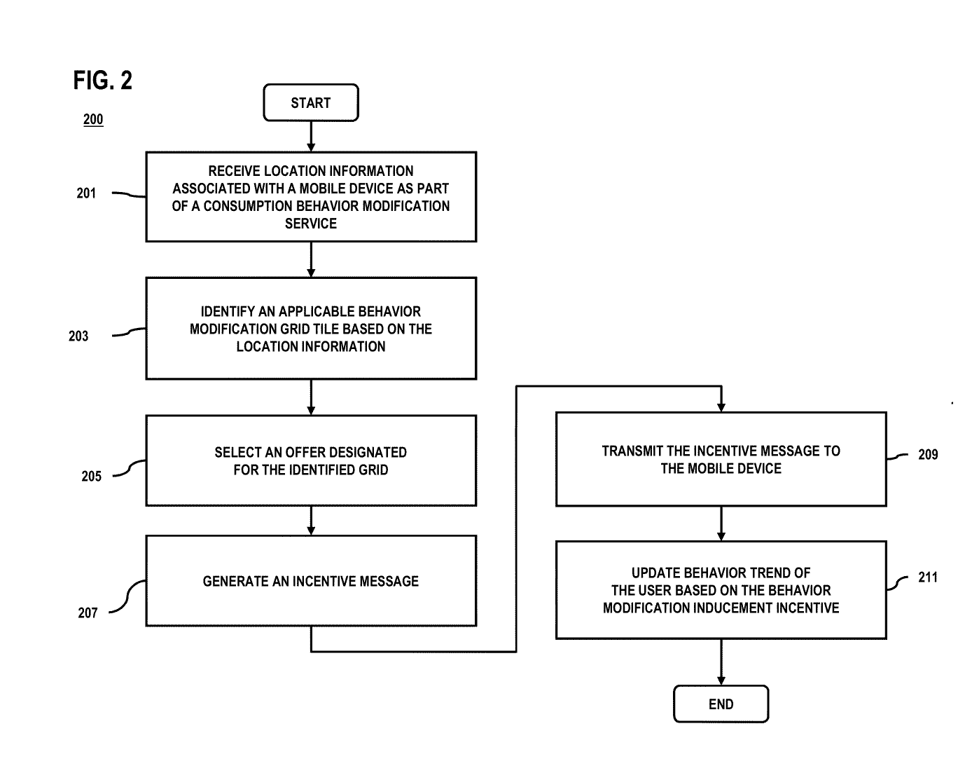

FIG. 2 is a flowchart of process for providing consumption behavior modification, according to one embodiment. For the purpose of illustration, the processes are described with respect to FIG. 1. It is noted that the steps of the processes may be performed in any suitable order as well as combined or separated in any suitable manner. Process 200 can be executed by platform 101, by way of example. In step 201, location information associated with a mobile device (e.g., user device 105a) is received as part of a consumption behavior modification service. To access the service, process 200 authenticates the mobile device 105a, and registers the mobile device for the consumption behavior modification service upon whether the authentication of the mobile device 105a was successful. An applicable behavior modification grid tile is identified, per step 203, based on the location information. The behavior modification grid tile is among a plurality of modification grid tiles that map to a behavior continuum space. In one embodiment, process 200 determines a behavior propensity value relating to probability of the mobile device 105a to be present at a point along the behavior continuum space. The behavior continuum space specifies categorical adjacencies that include one or more gaps associated with a cost and a benefit.

In step 205, an offer designated for the identified grid is selected. Process 200 identifies the behavior modification inducement incentive based on the determined behavior propensity value. Process 200 then generates, per step 207, an incentive message specifying a behavior modification inducement incentive for transmission to the mobile device 105a. Process 200 then transmits the incentive message to the mobile device 105a, as in step 209. In step 211, a behavior trend (or pattern) of a user is updated based on the behavior modification inducement incentive. In one embodiment, the behavior trend is updated in real-time, and thus, provides for the capability to dynamically create consumer offers.

According to certain embodiments, service provider network 109 may be a cloud based system that delivers the behavior modification campaign via the behavior modification campaign services platform 101. The behavior modification campaign platform can be a managed service platform that is a cloud based system capable of being deployed as individual cloud instances supporting different campaigns for behavior modification.

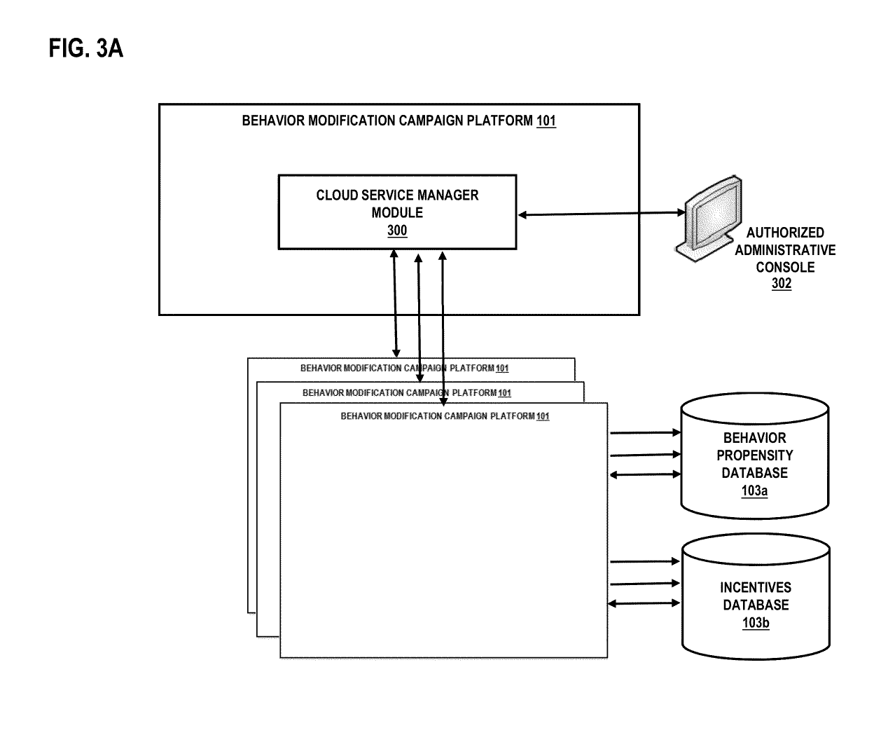

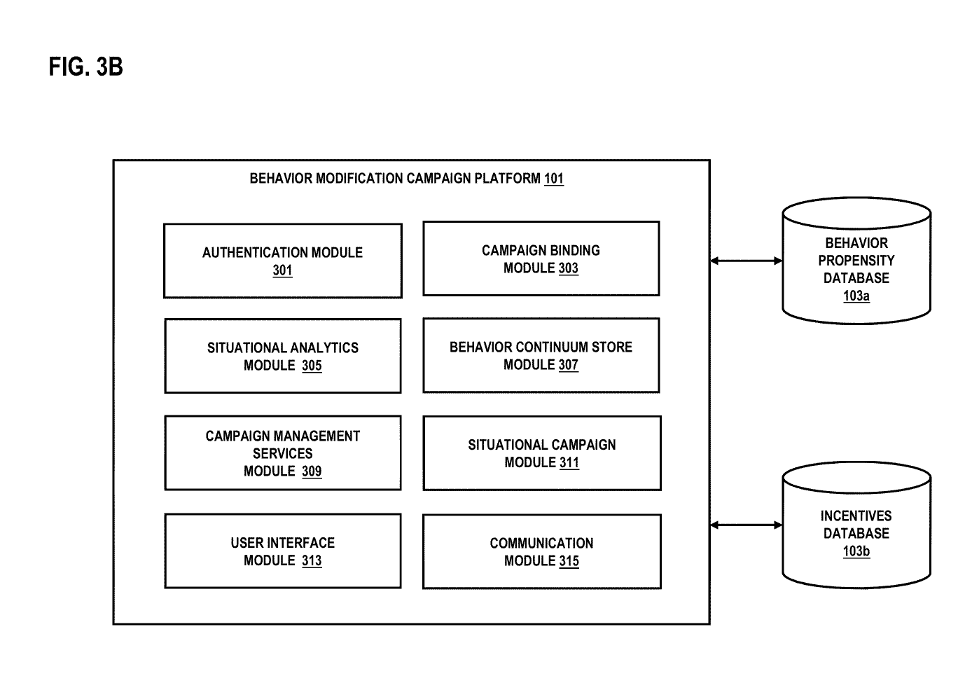

FIG. 3A is a diagram depicting the component that manages the lifecycle of behavior modification campaign platform managed service instance, according to one embodiment. The cloud service manager module 300 is a component that manages the lifecycle of a behavior modification campaign managed service instance. Under this scenario, the lifecycle management includes the authorized administrative console 302 starting up, changing storage or caching or associated memory resources to, persisting and shutting down a behavior modification campaign platform instance. Making a persistent copy of a behavior modification campaign platform instance involves transforming an online only instance for rapid deployment as a modification campaign via the managed cloud service. It not only generates the campaign platform instance for deployment, but also the companion mobile application that the consumer uses to interact with the campaign and the attendant campaign brand specific customization of icons.

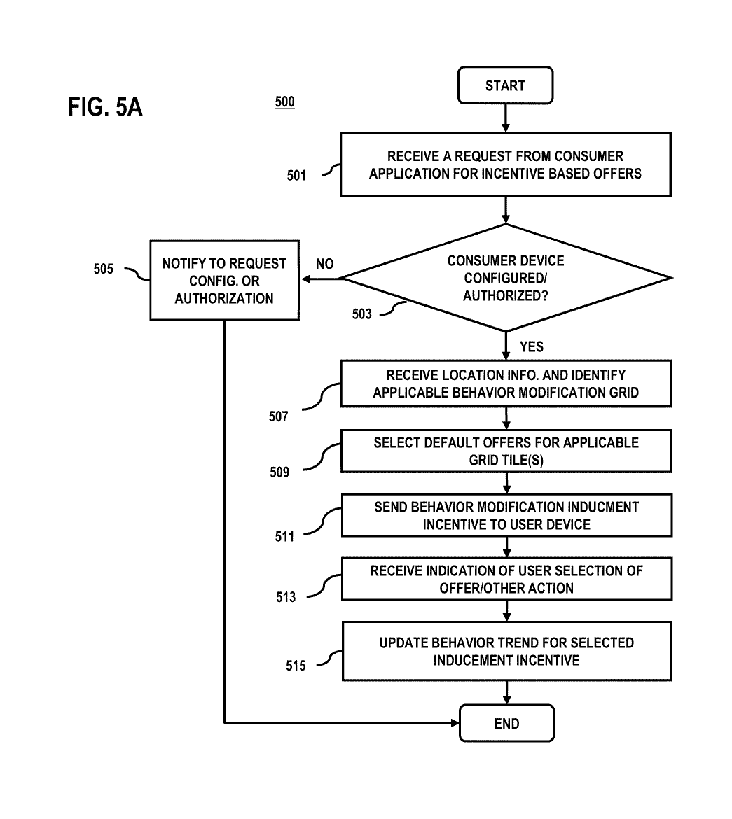

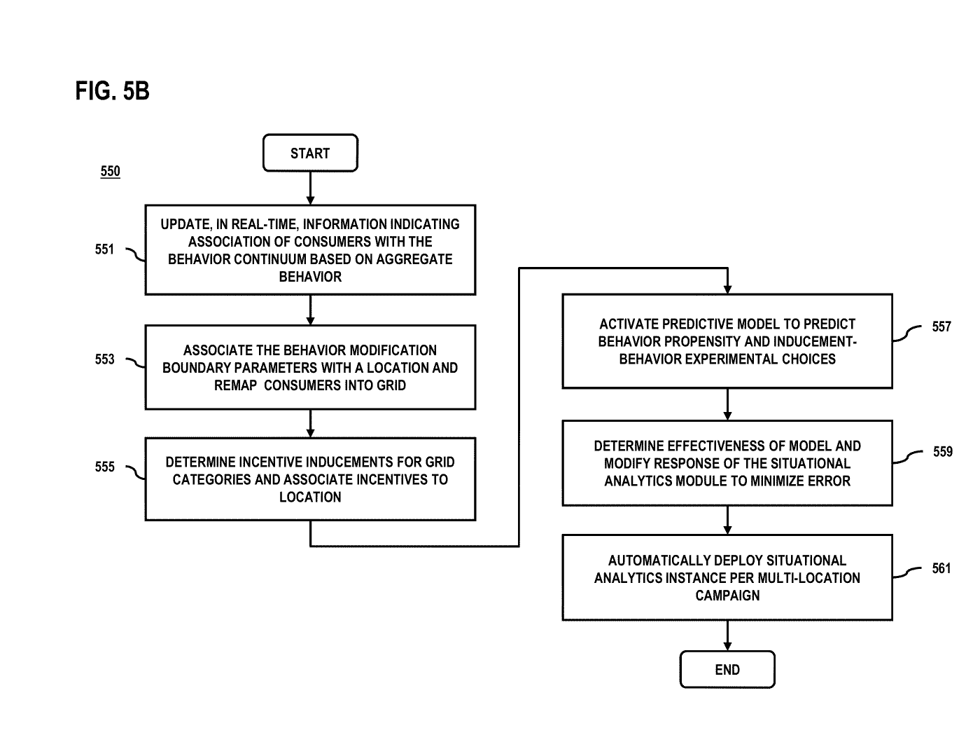

FIG. 3B is a diagram depicting the components of a behavior modification campaign platform, according to one embodiment. The behavior modification campaign platform 101 includes various executable modules for performing one or more computing, data processing and network based instructions that in combination provide a means for enabling consumption behavior modification services, as described in FIGS. 2 and 5. Such modules can be implemented in hardware, firmware, software or a combination thereof. By way of example, the platform 101 may include an authentication module 301, a campaign binding module 303, a situational analytics module 305, a behavior continuum store module 307, a campaign management services module 309, a situational campaign module 311, a user interface module 313, and a communication module 315. These modules 301-315 can interact with behavior propensity database 103a and incentives database 103b in support of their functions. According to some embodiments, digital incentives tied to physical and virtual rewards are stored within database 103b. In addition, the information of databases 103a and 103b are maintained and updated based, at least in part, on one or more transactions conducted with user devices 105 pertaining to various applications and functions of the consumption behavior modification services.

In one embodiment, an authentication module 201 authenticates users and corresponding user devices 105 for interaction with the platform 101. The authentication procedure may be established a first time via a subscription process then later executed by the subscribed device for enabling profile activation. By way of example, the subscription procedure may include user entry of contact information, device information and user device usage preferences.

Modules 303-311, as the functional core of the platform 101, operate to identify a “desirable” campaign population associated with certain behaviors and to utilize gaming theory to measure and influence their behavior by incorporating virtual and physical rewards tied to a “desirable” goal-state behavior. As such, platform 101, via these various modules 303-311, uses a behavior propensity classification matrix that is maintained by behavior propensity database 103a, and continually updates behavior category based signals.

Campaign binding module 303, which in one embodiment is deployed as a standalone server, hosts a subset of consenually mined data regarding device interaction, purchase behavior and user authorized data collection as part of a behavior continuum store. This store is managed by behavior continuum store module 307. Campaign binding module 303 provides for cross-referencing of behavior continuum and rewards (as maintained within databases 103a and 103b). According to one embodiment, this cross reference can be used to drive the real-time outcome of what rewards are offered. In this manner, consumer offers are dynamically produced and then generated, permitting a more effective inducement scheme than traditional static offers.

As shown, platform 101 employs a situational analytics module 305 (which may be implemented as a separate server) to host a predictive model markup language (PMML) model and to respond to real-time inputs. By way of example, a member of the experimental population that a campaign is directed at may be located at a specific grid on, e.g., the United States National Grid (USNG—a nonproprietary alphanumeric referencing system derived from the Military Grid Reference System). In this manner, either one of the user devices 105 may be associated with this campaign member. The device 105a, associated with this campaign member, authenticates itself with an authentication service of authentication module 301 and then registers with the situational campaign module 311.

In certain embodiments, situational campaign module 311 hosts campaign management services. Module 311 provides real-time front end support and acts as a proxy for the situational analytics module 305.

In one embodiment, the user interface module 313 facilitates generation of various interfaces for enabling users to interact with the behavior modification campaign platform 101. This includes, for example, generation of a login interface for enabling user registration and/or access to the platform 101. By way of example, the user interface module 313 may generate different user interface elements for selection by registered users. It is noted that the user interface module 313 may be activated by way of various application programming interfaces (APIs) or other function calls at a computing device of the third party content provider.

In one embodiment, the communication module 315 executes various protocols and data sharing techniques for enabling collaborative execution between the behavior modification campaign platform 101 and the applications 107 and/or user device 105. In addition, the communication module 215 enables generation of signals for communicating with various elements of the service provider network, including various gateways, policy configuration functions and the like.

The above described modules 201-215 and components of the behavior modification campaign platform 101 can be implemented in hardware, firmware, software, or a combination thereof. Though depicted as a separate entity in FIG. 1, it is contemplated that the platform 101 may be implemented for direct operation by various components of the service provider network. As such, the platform 101 generates direct signal inputs by way of the operating system of the network access point. In another embodiment, one or more of the modules 301-315 may be implemented for operation as a platform 101 maintained as a hosted or cloud based solution, as earlier noted.

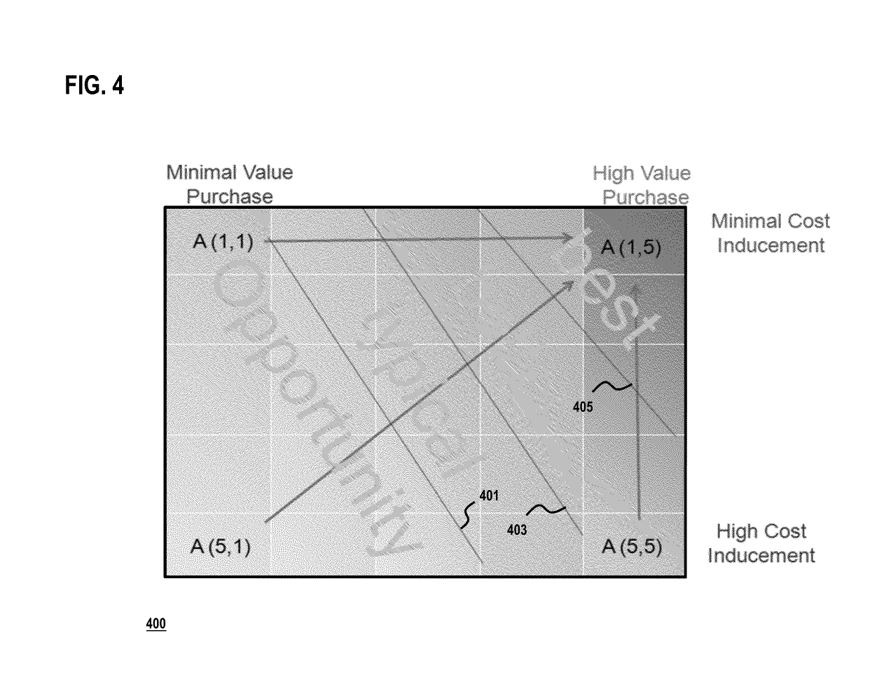

FIG. 4 is a diagram of an example of a behavior continuum showing a 5×5 behavior propensity matrix, according to one embodiment. In certain embodiments, behavior propensity is described as the probability of a campaign-member entity to be present in a given location in a behavior continuum space. A behavior continuum space, in one embodiment, is defined in terms of categorical adjacencies including gaps associated with a cost and benefit to the system. For example, the cost can be a range of inducements from minimal cost to high cost. The benefit to the system is associated with a range starting from a minimal purchase price (for example “$—spend at a vend machine”) to high value purchase (maximum vend transaction yield).

For purpose of explanation, an equivalent healthcare example of “benefit to the system” could be a range of unhealthy to healthy behavior. A typical categorical adjacency can be a two dimensional vector A_{5×5} with A(2,2) representing the category and values surrounding A(2,2) in eight geographic directions. The affinity continuum itself can be defined as two dimensional vector A_{m×n} with pre-defined mapping of the categories to vector locations in this matrix. Because of the potentially large size of data and the latency involved in applying the behavior propensity vector to create a behavior continuum in real-time, this activity can be performed prior to engaging in the situational analytics.

Thereafter, the categorization of content can be performed specific to the profile created in the PMML model. As time progresses, the grids can be coded (e.g., visually color coded in a presentation) such that a change can be indicated by a color change based on the PMML model; the change can be further based on an output score that is accrued cumulatively.

By storing the model output (via a campaign binding module 303) as a behavior propensity matrix, this matrix can be populated for the entire USNG and be made available for near-real-time update as well as retrieval via the campaign management services module 309.

In the example of FIG. 4, at the time that the campaign management service starts up, the grid 400 in concept can be coded (either through shading and/or coloring) to provide different indicia of behavior states. The use of a standardized grid system, in some embodiments, binds space, time and context. The “coloring” of this bound variable by category allows for a mixing of the colors, and hence an output coloring that is representative of the categories and the bound variable.

According to certain embodiments, triggers from the behavior modification campaign process can be made less or more sensitive based on scoring thresholds—i.e. the lines 401-405 shown on FIG. 4. A goal seeking algorithm can be utilized by platform 101 to identify the key cost-benefit goal that is “optimal”—for example A(1,5) and immediately adjacent—i.e. between the current state and the ideal state. An inducement is offered to the campaign member and the outcome noted. Depending on cost-to-date, the next inducement could be higher cost or lower cost. As campaign members are navigated through the behavior continuum, the output coloring or thresholds may themselves adapt to new settings. This approach can be used for widely varying applications ranging from retail to healthcare, etc.

As mentioned, behavior influencing techniques from the gaming industry referred to as quest-gamification have been transformed into an interface for setting a goal state, tying rewards to the progress towards the goal and allowing the campaign-member facing delivery execution to be “gamified” in the form of a “quest.” For example (per FIG. 4), in the context of a vending machine, the user or consumer may attempt to move the vended transaction amount from a sub-par $0.50 (Aₘ₁) to $4.50 (A_{m,5}). For every vending item, a free vending item could be offered (A_{5,n}); this is an example of a high cost inducement or for every nine vending items. Also, the tenth one could be free (A_{3,n}), which is an example of a relatively low cost inducement or a virtual reward like the member name on a leader board (A_{1,n}) (which would be an example of a minimal cost inducement).

For example, the quest aspect of the gamification can refer to the campaign-member being asked to locate a specific hidden sign near the vending location. The inducements during a quest episode can be tied to, e.g., virtual currency until the moment of redemption. On redemption (i.e. currency settlement), the campaign-member's current location on the continuum is updated.

The approach of platform 101 supports the rapid creation of numerous applications on mobile devices (e.g., devices 105a-105n) via the quest-gamification framework with all the key components supported in the cloud 109. Offers can be made while within a quest episode and can be the equivalent of zooming into one of the elements of the matrix above and dealing with a quest-behavior continuum. The approach of platform 101 thus has powerful recursive implications for the creation of multi-level quests as a means of behavior inducement.

FIGS. 5A and 5B are flowcharts of processes for providing behavior modification campaign services, according to various embodiments. For the purpose of illustration, the processes are described with respect to FIG. 1. It is noted that the steps of the processes may be performed in any suitable order as well as combined or separated in any suitable manner. Processes 500 and 550 can be executed by platform 101, by way of example. In step 501, process 500 receives a request from consumer application for incentive based offers. Process 500 then determines whether a consumer (e.g., user device 105a) is properly configured and/or authorized to the behavior modification campaign services, per step 503. For example, platform 101 can perform this step using authentication module 301 to determine whether the device 105a is an approved device 105a for the service. If the device 105a fails this authentication process, a notification is generated and transmitted to the device 105a to request that such configuration or authorization be initiated by the device 105a, per step 505.

Upon successful authentication (authorization), location information is acquired for the device 105a, as in step 507. In one embodiment, the location information is used to identify the applicable behavior modification grid associated with the behavior continuum (e.g., grid 400 of FIG. 4). By way of example, platform 101 invokes the campaign binding module 303 to select a default behavior modification inducement incentive (e.g., offer) for the applicable grid tile(s), per step 509. This incentive can be retrieved from incentives database 103b. In step 511, the behavior modification inducement incentive (or incentives) is forwarded to user device 105a; in this example, this device 105a can be a mobile device, such as a cellular phone (e.g., smartphone). At this point, user device 105a, as in step 513, may select one of the incentives that were forwarded (assuming multiple incentives were provided); alternatively or additionally, another action can be initiated by the device 105a. Process 500 then updates the behavior trend for the selected inducement incentive, as in step 515. The behavior trend information can be stored in behavior propensity database 103a.

As shown in FIG. 5B, process 550 involves the use of information relating to the aggregate behavior of all users/consumers in developing the proper inducement incentives. In step 551, process 550 updates, in real-time, information indicating the association of consumers with the behavior continuum based on the aggregate behavior. It is noted that such aggregate behavior can be continually updated to optimize the choice of incentives. In step 553, process 550 associates behavior modification boundary parameters with a location of the user device 105a, and remaps the consumers to the grid (per step 553). Next, as in step 555, incentive inducements are determined for the grid categories, and incentives are associated with the location.

In step 557, process 550 activates a predictive model (e.g., PMML model) that predicts behavior propensity and inducement behavior experimental choices. Process 550 then determines the effectiveness of the PMML model and modifies the response of the situational analytics module 305 to minimize errors, as in step 559. In step 561, process 550, using situational analytics module 305, automatically deploys a situational analytics instance per multi-location campaign.

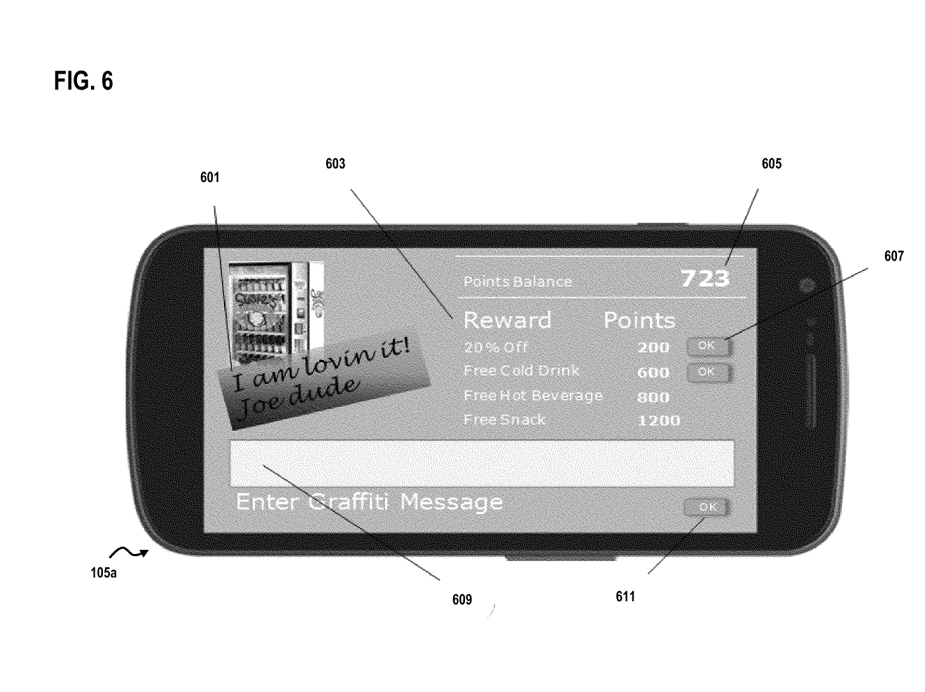

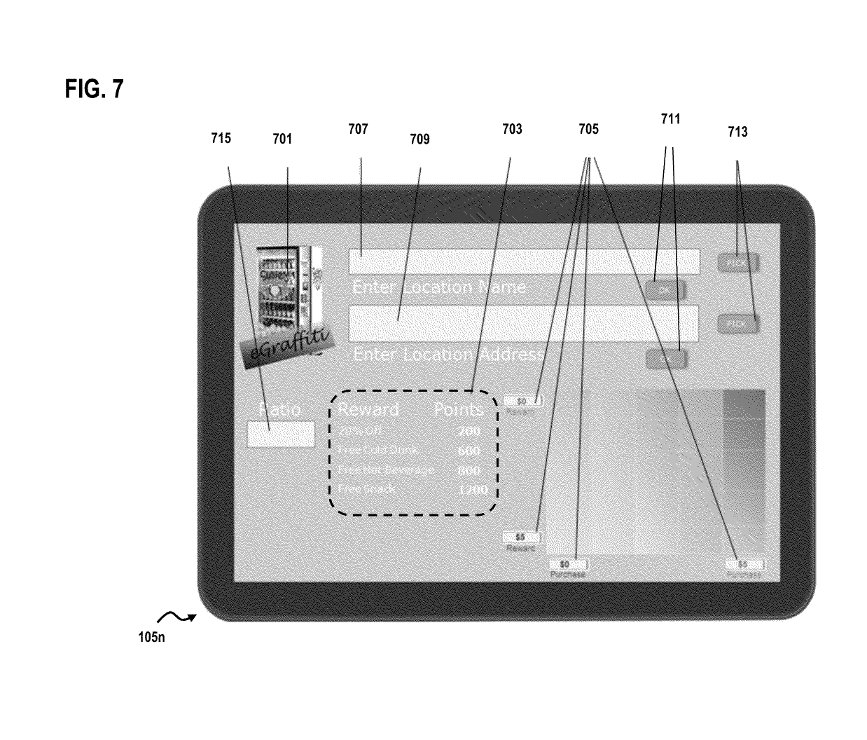

FIGS. 6 and 7 are diagrams of a mobile device configured to provide a user interface that supports a behavior modification service, according to various embodiments. Under the scenario of FIG. 6, user device 105a is a smartphone that is configured to present a graphical user interface (GUI) in support of the behavior modification service provided by platform 101. In this example, device 105a is identified with a particular location that is served by a vending machine, as indicated by icon 601. To induce user of device 105a to conduct more or different transactions with the vending machine, device 105a displays inducement incentives within section 603, and the balance of reward points that has been accumulated for the user per area 605 (which shows that “723” points have been earned through the particular vending merchant).

As shown, numerous offers are provided along with the required points for redeeming these incentives. For example, one offer involves providing the user with a 20% discount on the price of the vending item (selection of this offer would entail usage of 200 points). Also, the user may select to receive a free cold drink within the vending machine if the user uses 600 points. Other incentives include a free hot beverage (800 points) and a free snack (1200 points). In this example, the only two viable options are the 20% discount and the free cold drink, as the user has only 723 points—that is, the other options have points that exceed 723 points (namely 800 and 1200 points). Therefore, OK buttons 607 exists only for the two available options.

To engage the user, a text box 609 is provided to permit the user to enter a graffiti message to be associated with this particular vending machine. Once a message is inputted, selection of the OK button 611 will submit the message on the graffiti board; for example, in this case, the phrase “I am lovin it! Joe dude” was entered and posted.

As shown in FIG. 7, mobile device 105n can be a tablet that provides a user interface that resembles the interface of FIG. 6, whereby a vending machine icon 701 is displayed along with a graffiti message. Also, in this example, inducement incentives are provided along with reward points (shown in area 703). By contrast, user interface of FIG. 7 provides for an illustration of a behavior grid with reward points 705. Also, the user interface includes a text box 707 to permit entry of a location name (“Enter Location Name”), as well as a text box 709 for entry of a location address (“Enter Location Address”). Corresponding OK buttons 711 are utilized to submit the text entered in the boxes 707 and 709. Further, corresponding “Pick” buttons 713 can be utilized if the Location Name and Location Address are automatically provided to the user for selection. Moreover, user interface of FIG. 7 provides for a text box 715 to specify a ratio value relating to the reward points.

The processes described herein for providing dynamic consumer offers may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

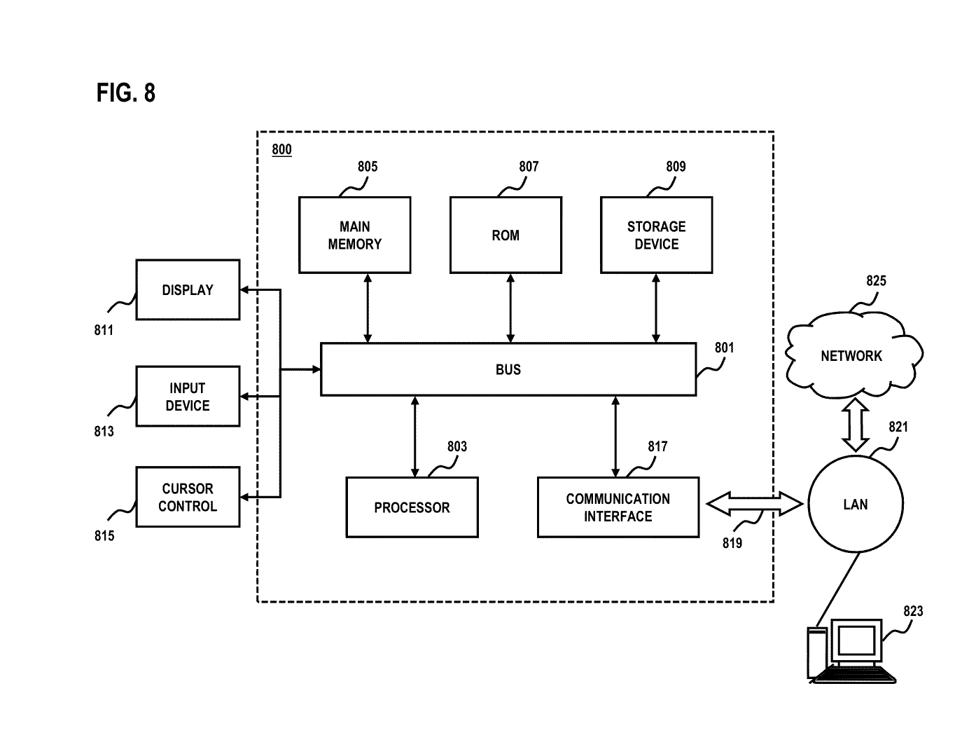

FIG. 8 is a diagram of a computer system that can be used to implement various exemplary embodiments. The computer system 800 includes a bus 801 or other communication mechanism for communicating information and one or more processors (of which one is shown) 803 coupled to the bus 801 for processing information. The computer system 800 also includes main memory 805, such as a random access memory (RAM) or other dynamic storage device, coupled to the bus 801 for storing information and instructions to be executed by the processor 803. Main memory 805 can also be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for adjusting cursor movement on the display 811.

According to an embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multiprocessing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

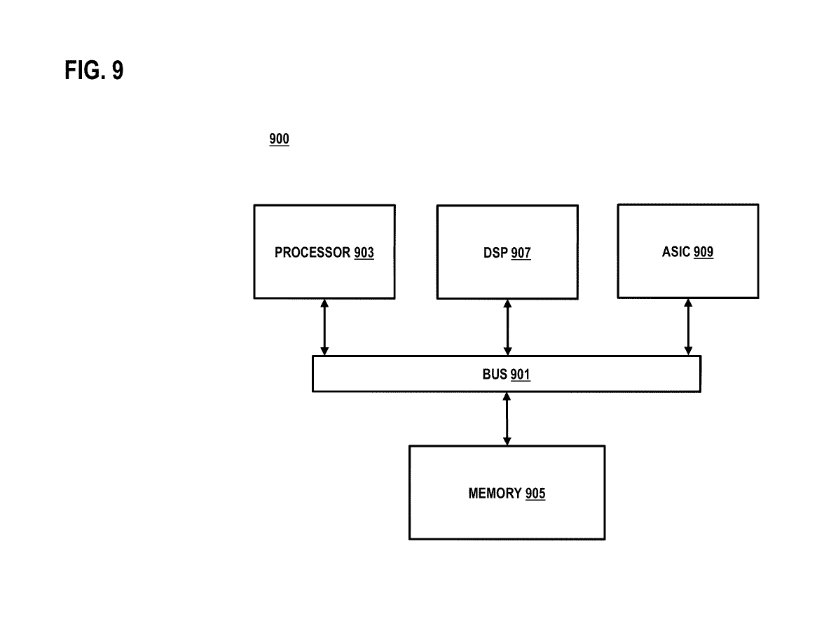

FIG. 9 illustrates a chip set or chip 900 upon which an embodiment of the invention may be implemented. Chip set 900 is programmed for to enable controlled access to a limited set of remote services associated with a device as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of enabling controlled access to a limited set of remote services associated with a device.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein for to enable controlled access to a limited set of remote services associated with a device. The memory 905 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

1. A method comprising:
determining a plurality of modification grid tiles mapping to a behavior continuum space, the behavior continuum space specifying a plurality of categorical adjacencies that include one or more gaps associated with a cost and a benefit;
receiving location information associated with a mobile device as part of a consumption behavior modification service;
identifying, by a processor, an applicable behavior modification grid tile of the plurality of modification grid tiles based on the location information;
selecting one of a plurality of offers, the one of the plurality of offers being designated for the identified applicable behavior modification grid tile; and
generating an incentive message specifying a behavior modification inducement incentive for transmission to the mobile device.

2. A method according to claim 1, wherein the behavior continuum space is predefined, the method further comprising:
transmitting the incentive message to the mobile device; and
updating a behavior trend of a user based on the behavior modification inducement incentive.

3. A method according to claim 1, further comprising:
determining a behavior propensity value relating to a probability of the mobile device to be present at a point along the behavior continuum space; and
identifying the behavior modification inducement incentive based on the determined behavior propensity value.

4. A method according to claim 1, further comprising:
authenticating the mobile device; and
registering the mobile device for the consumption behavior modification service upon the authentication of the mobile device.

5. A method according to claim 1, further comprising:
updating, in real-time, a plurality of user profiles associated with the behavior continuum space.

6. A method according to claim 5, further comprising:
associating one or more behavior modification boundary parameters with a location; and
remapping the user profiles onto the modification grid tiles.

7. A method according to claim 1, further comprising:
activating a predictive model to predict behavior propensity and to predict inducement behavior experimental choices;
determining effectiveness of the predictive model;
modifying the predictive model according to the determined effectiveness; and
deploying situational analytics instance based on the modified predictive model.

8. An apparatus comprising:
at least one processor; and
at least one memory including computer program code for one or more programs,
the at least one memory and the computer program code configured to, with the at least one processor, cause the apparatus to perform at least the following,
determine a plurality of modification grid tiles mapping to a behavior continuum space, the behavior continuum space specifying a plurality of categorical adjacencies that include one or more gaps associated with a cost and a benefit;
receive location information associated with a mobile device as part of a consumption behavior modification service,
identify an applicable behavior modification grid tile of the plurality of modification grid tiles based on the location information,
select one of a plurality of offers, the one of the plurality of offers being designated for the identified applicable behavior modification grid tile, and
generate an incentive message specifying a behavior modification inducement incentive for transmission to the mobile device.

9. An apparatus according to claim 8, wherein the apparatus is further caused to:
transmit the incentive message to the mobile device; and
update a behavior trend of a user based on the behavior modification inducement incentive.

10. An apparatus according to claim 8, wherein the apparatus is further caused to:
determine a behavior propensity value relating to a probability of the mobile device to be present at a point along the behavior continuum space; and
identify the behavior modification inducement incentive based on the determined behavior propensity value.

11. An apparatus according to claim 8, wherein the apparatus is further caused to:
authenticate the mobile device; and
register the mobile device for the consumption behavior modification service upon the authentication of the mobile device.

12. An apparatus according to claim 8, wherein the apparatus is further caused to:
update, in real-time, a plurality of user profiles associated with the behavior continuum space.

13. An apparatus according to claim 12, wherein the apparatus is further caused to:
associate one or more behavior modification boundary parameters with a location; and
remap the user profiles onto the modification grid tiles.

14. An apparatus according to claim 8, wherein the apparatus is further caused to:
activate a predictive model to predict behavior propensity and to predict inducement behavior experimental choices;
determine effectiveness of the predictive model;
modify the predictive model according to the determined effectiveness; and
deploy situational analytics instance based on the modified predictive model.

15. A system comprising:
a behavior propensity database configured to store a behavior modification grid specifying a plurality of modification grid tiles mapping to a behavior continuum space, wherein the behavior continuum space specifies a plurality of categorical adjacencies that include one or more gaps associated with a cost and a benefit; and
a behavior modification campaign platform coupled to the behavior propensity database and configured to receive location information associated with a mobile device as part of a consumption behavior modification service, and to identify, by a processor, one of the behavior modification grid tiles based on the location information,
wherein the behavior modification campaign platform is further configured to select one of a plurality of offers, the one of the plurality of offers being designated for the identified behavior modification grid tile, and to generate an incentive message specifying a behavior modification inducement incentive for transmission to the mobile device.

16. A system according to claim 15, wherein the behavior modification campaign platform is further configured to transmit the incentive message to the mobile device, and to update a behavior trend of a user based on the behavior modification inducement incentive.

17. A system according to claim 15, wherein the behavior modification campaign platform is further configured to determine a behavior propensity value relating to a probability of the mobile device to be present at a point along the behavior continuum space, wherein the behavior modification campaign platform being further configured to identify the behavior modification inducement incentive based on the determined behavior propensity value.

18. A system according to claim 15, wherein the behavior modification campaign platform is further configured to authenticate the mobile device, and to register the mobile device for the consumption behavior modification service upon the authentication of the mobile device.

19. A system according to claim 15, wherein the behavior modification campaign platform is further configured to update, in real-time, a plurality of user profiles associated with the behavior continuum space.

20. A system according to claim 19, wherein the behavior modification campaign platform is further configured to associate one or more behavior modification boundary parameters with a location, and to remap the user profiles onto the modification grid tiles.

21. A system according to claim 15, wherein the behavior modification campaign platform is further configured to activate a predictive model to predict behavior propensity and to predict inducement behavior experimental choices; to determine effectiveness of the predictive model; to modify the predictive model according to the determined effectiveness; and to deploy situational analytics instance based on the modified predictive model.
